(19) United States
(12) Patent Application Publication
(10) Pub. No.: US 2007/0037125 A1
(43) Pub. Date: Feb. 15, 2007

(54) Ultrasonic sensor for dental applications

(76) Inventors: Roman Gr. Maev, Windsor (CA); Liudmila A. Denisova, Moscow (RU); Fedar M. Seviaryn, Windsor (CA); George G. Grayson, Windsor (CA); Evgeny Yr. Bakulin, Windsor (CA)

Correspondence Address: CARLSON, GASKEY & OLDS, P.C., 400 WEST MAPLE ROAD, SUITE 350, BIRMINGHAM, MI, 48009, US

(21) Appl. No.: 11/496,000

(22) Filed: Jul. 28, 2006

Related U.S. Application Data
(60) Provisional application No. 60/703,239, filed on Jul. 28, 2005.
(60) Provisional application No. 60/754,166, filed on Dec. 27, 2005.

(51) Int. Cl. A61C 3/00; A61C 5/00

(52) U.S. Cl. 433/215; 433/29

(57) ABSTRACT

This invention includes a method and a device for measuring a tooth. The method includes generating an ultrasonic impulse, which is echoed off of an area of the tooth. By analyzing the echo, the geometry of the tooth can be determined.

This application claims priority to Provisional Application U.S. Ser. No. 60/703,239 filed Jul. 28, 2005, and to Provisional Application U.S. Ser. No. 60/754,166, filed Dec. 27, 2005.

### BACKGROUND OF THE INVENTION

This invention relates generally to an ultrasonic measurement device, and specifically to an ultrasonic measurement device used in dental applications.

A tooth is composed of multiple layers each having an associated thickness. During a dental treatment it is useful to estimate the thickness of the layers of the tooth and to determine the overall internal tooth structure. It is useful for a dentist to know the thickness of the enamel or dentin layer of the tooth to fully understand the extent of dental work required. As an example, information relating to the thickness of the enamel/dentin layer may aid in planning and/or controlling the depth of a drilling bore through the enamel layer. In addition, such information may dictate the necessary amount of surgical interference. Formerly, to obtain such information about the internal structure of the tooth, the dentist may have relied on an invasive procedure or radiographic analysis.

In addition to evaluating the structure of the tooth, dentists often need to evaluate the quality of bonds between a dental prosthesis and the tooth. As an example, fixed permanent dental prostheses are typically adhered to the tooth utilizing a layer of adhesive. After securing the dental prosthesis to the tooth, it is difficult to detect and locate flaws in the layer of adhesive or the tooth without disturbing the adhesive bond. As a result, the dentist may have to remove the dental prosthesis before evaluating the quality of the bond.

It would be desirable to determine the thickness of dental layers without requiring an invasive procedure.

It would be further desirable to estimate adhesion quality and locate flaws in the adhesive layer or flaws in the tooth structure without removing a dental prosthesis.

### SUMMARY OF THE INVENTION

This invention includes a method and a device for measuring a tooth. The method includes generating an ultrasonic impulse, which is echoed off of an area of the tooth. By analyzing the echo, a user can determine the geometry of the tooth.

Boundaries between layers of the tooth may produce distinguishable echoes. Because ultrasonic impulses travel with known speeds through different areas of the tooth, analysis of the echo may include comparing the time difference between receiving two echoes from differing portions of the tooth. Accordingly, a user can establish where those boundaries are based upon the timing differences between the echoes. In addition to evaluating structure within the tooth, the present invention may also be used to evaluate areas proximate to the tooth. A user may display the echoes graphically to aid in identifying distinct boundary layers.

The device used to measure the tooth includes a transducer for generating an ultrasonic impulse and a receiver for accepting an echo from the tooth. The portion of the device including the transducer and receiver is ordinarily handheld. The device also includes a computer for converting the data relating to the echoes into data representative of the tooth geometry. The computer may produce a graphical representation of the echoes to aid in identifying areas of the tooth. Alternatively, the computer calculates the thickness of a layer of the tooth and generates measurement information. In addition to calculating the internal geometries of the tooth, the device also may calculate geometries based on echoes from areas other than the tooth.

### BRIEF DESCRIPTION OF THE DRAWINGS

FIG. 1 is a cross-sectional view of a tooth and a dental ultrasonic hand-piece in the case of enamel thickness measurement.

FIG. 2 is a cross-sectional view of a tooth and the dental ultrasonic sensor in the case of measuring the distance from the surface to pulp.

FIG. 3 is a cross-sectional view of a tooth with a crown prosthesis.

FIG. 4 is a cross-sectional view of a tooth with a filling and a void.

FIG. 5 schematically illustrates the components of a dental measurement system.

FIG. 6 illustrates a dental measurement system.

### DETAILED DESCRIPTION OF THE PREFERRED EMBODIMENT

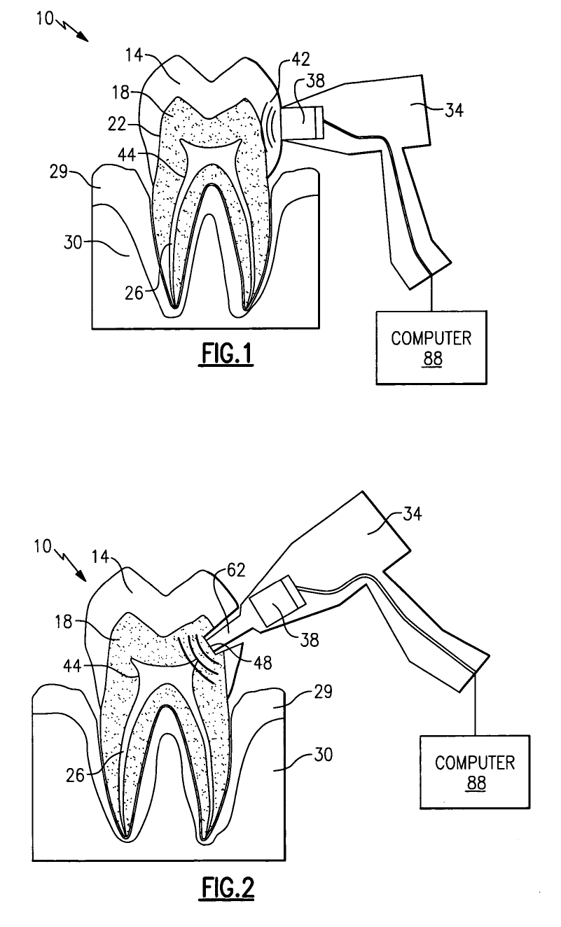

FIG. 1 illustrates a dental hand-piece 34 for examining the internal layers of a tooth 10. As shown in the cross-sectional view, an enamel layer 14 partially covers a dentine layer 18 forming a dentine-enamel interface 22. A pulp chamber and root canal 26 is embedded within the dentine layer 18 and supporting tissue (gingiva 29 and bone 30) anchors the tooth 10 in position.

The dental hand-piece 34 incorporates a piezoelectric transducer 38, which emits a brief ultrasonic impulse 42 toward the tooth 10 at a known frequency. The tooth 10 reflects the ultrasonic impulse 42 back to the dental hand-piece 34. Different areas of the tooth 10, e.g. the interfaces between layers of the tooth 10, reflect varying echoes back to the dental hand-piece 34, creating an ultrasonic echo. Accordingly, the thickness of a layer of the tooth 10 can be determined by measuring time delay between the ultrasonic echoes reflected from the appropriate portion of the tooth 10, such as the dentine-enamel interface 22. As a result, it is not necessary to remove the tooth 10 from the supporting tissue to evaluate the structure of the tooth 10.

In this example, the piezoelectric transducer 38 communicates with a computer 88 having pulse generating instrumentation, a receiver, and an analog to digital converter. The piezoelectric transducer 38 receives the ultrasonic echo, and after measuring the reflection time of the ultrasonic echo, an operator can determine the time of flight. For example, multiplying the time delay between the ultrasonic impulses 42 reflected from the borders of the layers of the tooth 10 by the known velocity of the ultrasonic impulse 42 produces the thickness of the layer of the tooth 10.

The ultrasonic impulse 42 echoes off of all portions of the tooth 10, the interfaces between the main layers of tooth 10, e.g., the enamel-dentine interface 22, produce a substantial echo, which helps to identify the location of the interfaces between the main layers of the tooth 10. For instance, a graphical representation of the echoes may illustrate the echoes from the enamel-dentine interface 22 as having greater amplitudes and shorter time delay than echoes from other portions of the tooth 10. A person skilled in the art could identify the interfaces after observing the graphical representation. Preferably, the computer 88 interprets the amplitudes and delay times of the echoes and displays the thicknesses of the various layers.

As an example, the thickness of the enamel layer 14 of the tooth 10 can be determined as follows. The piezoelectric transducer 38 first transmits the ultrasonic impulse 42 into the tooth 10. The ultrasonic impulse 42 reflects two distinguishable echoes when the ultrasonic impulse 42 reaches the surface of the enamel 14 and the dentine-enamel interface 22 respectively. The velocity of the ultrasonic impulse 42 through enamel is known. Accordingly, measuring the time delay between the two echoes, multiplying the time delay by the sound velocity, and dividing the product by the factor of 2 produces the thickness of the enamel 14.

FIG. 2 illustrates the piezoelectric transducer 38 mounted into dental hand-piece 34 (different shape). In this example, the probe 38, incorporates a nose-shaped cylindrical probe tip 62 having a cylindrical cross section. The piezoelectric transducer 38 produces the ultrasonic impulse 42 as the probe tip 62 is inserted into a bore 48 in the enamel layer 14 and the dentine layer 18 of the tooth 10. Similar to determining the thickness of the enamel layer 14, the thickness of the bored portion of the dentine layer 18 may be calculated using the echoes from the bottom of the drilled bore 48 and the dentine-pulp interface 44 as well a the sound velocity through dentin.

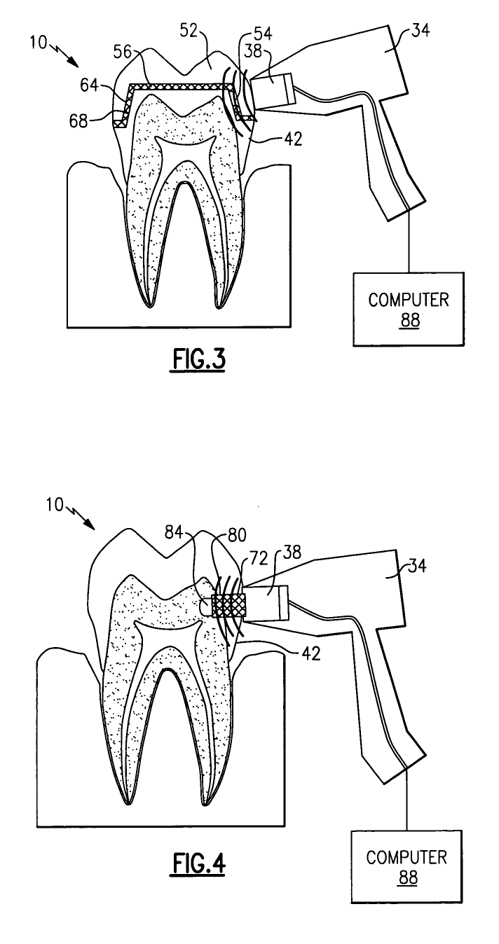

As shown in FIG. 3, a crown 52, a type of dental prosthesis, may be secured to the tooth 10 using an adhesive 56. In so doing creating a crown-adhesive interface 64 and an adhesive-enamel interface 68 or if enamel is removed, then an adhesive/dentin interface would occur. The dental hand-piece 34 and the piezoelectric transducer 38, with or without the tip attached, direct the ultrasonic impulse 42 to the tooth 10 and the crown 52. Both the crown-adhesive interface 64 and the adhesive-enamel interface 68 produce distinguishable echoes. Flaws in the adhesive flaws or an adhesive void 54 can be located by interpreting amplitude increases and changes in the returning echoes of the ultrasonic impulse 42. For example, a distortion in the return echo may identify the adhesive void 54.

FIG. 4 illustrates that the present invention may also be used to detect a cavity 84 between the tooth 10 and a filling 72. Adding the filling 72 to the tooth 10 creates a filling-dentin interface 80. As shown, the piezoelectric transducer 38 transmits the ultrasonic impulse 42 toward the filling 72 producing echoes. The ultrasonic impulse 42 travels from the piezoelectric transducer 38 and echoes off the filling-dentin interface 80. Increases in the amplitude of the return signal may indicate the cavity 84 between the filling 72 and the tooth 10.

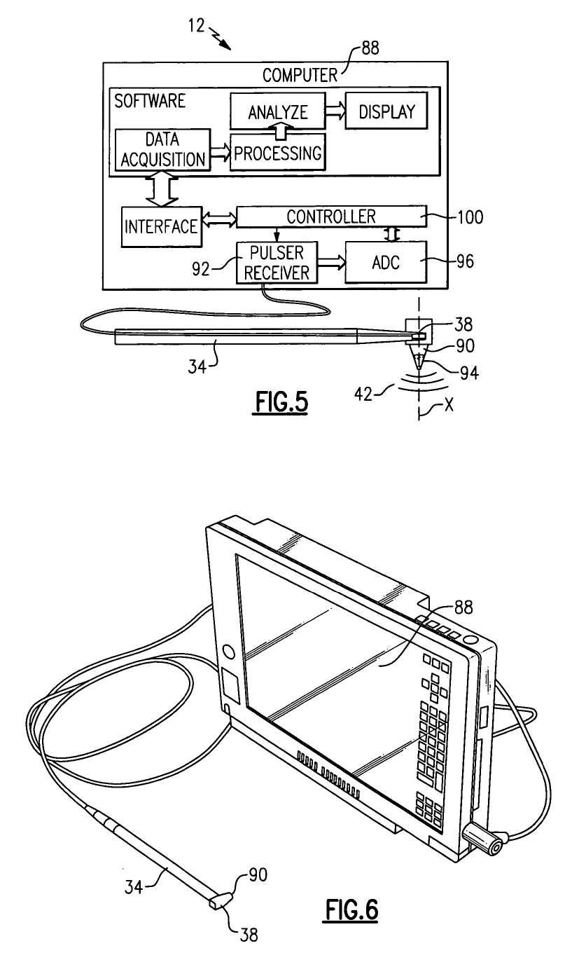

FIG. 5 is a schematic illustration of an exemplary dental measurement system 12 incorporating the dental hand-piece 34 communicating with a computer 88. As shown, the piezoelectric transducer 38 with an attached ultrasonic guidance element 90 is located at one end of the dental hand-piece 34. The example ultrasonic guidance element 90 is tapered to focus the ultrasonic impulses 42 from the piezoelectric transducer 38 to the tooth 10 or other desired area.

To achieve maximum ultrasonic impulse 42 penetrations into the tooth 10, axis X taken through the ultrasonic guidance element 90 should remain generally perpendicular to the surface of the tooth 10. Irregularities in the surface of the tooth 10 may increase the difficulty of maintaining this position and elements of the ultrasonic guidance element 90 that do not maintain this position may produce distorted echoes of the ultrasonic impulse 42 that can be correspondingly interpreted. To counteract this result, a user may tilt the hand-piece 34 among varying angles while the ultrasonic impulse 42 is being operated. As is known in the art, the amplitudes of the signal at various angles can be stored, compared and analyzed to determine when the acoustical beam irradiated by the piezoelectric transducer 38 was perpendicular to the surface of the tooth 10, such that the perpendicular measurement is used.

Depending on the space constraints and handling desires, other varieties of dental hand pieces 34 may be used with differently shaped tips. A cylindrical probe tip 62 (FIG. 2) may be used. The dental hand piece 34 also may incorporate protective measures, such as a sterile/aseptic sleeve, for bio-safety concerns.

The size of the interchangeable ultrasonic guidance element 90 in the current invention aids in maintaining the position of the dental hand-piece 34 and better directs the ultrasonic impulse 42 into the tooth 10. In addition, modifying the ultrasonic guidance element 90 enables access to many hard to reach areas, e.g., between the teeth 10, at the lower edge of the crown 52.

In this example, the dental hand-piece 34 and piezoelectric transducer 38 communicate echoes of the ultrasonic impulse 42 to a pulser-receiver 92. An analog-to-digital converter 96 coverts the echoes to the appropriate data format and moves the data through a controller 100 interfacing with a computer 88. The computer 88 processes and analyzes the data using an algorithm, and then displays the data, typically in a numerical and graphical format, based upon time dependence of echoes.

Although this example discloses that the computer 88 contains the relevant instrumentation, those skilled in the art, and having the benefit of this disclosure, may be able to identify other suitable instrumentation set-ups. For example, the dental hand-piece may separately connect to an ultrasonic generator and a graphical display.

FIG. 6 shows the example dental measurement system 12 including the ultrasonic guidance element 90, and incorporated piezoelectric transducer 38, mounted to the dental hand-piece 34. The computer 88 communicates with the pulser-receiver in the dental hand-piece 34. When a user directs the dental hand-piece toward a tooth 10 (FIG. 1), the computer may display, in real-time and in a graphical format, the measurements of the tooth 10 based on the echoes off of the tooth 10. In addition, the display may include real-time visualization of the tooth 10 and any noted defects in the tooth 10, enabling real time examination of the tooth 10. The small portable size of the dental hand-piece 34 and the computer 88 aid in incorporating the dental measurement system 12 into clinical practice.

Although a preferred embodiment of this invention has been disclosed, a worker of ordinary skill in this art would recognize that certain modifications would come within the scope of this invention.

What is claimed is:

1. A method for evaluating the structure of a tooth including the steps of:
a) generating an ultrasonic impulse;
b) receiving at least one echo of said ultrasonic impulse from internal structures of the said tooth;
c) analyzing the at least one echo; and
d) determining a geometry of said tooth based on said step c).

2. The method of claim 1 wherein step b) includes receiving a first echo from a first portion of said tooth and a second echo from a second portion of said tooth.

3. The method of claim 2 wherein said first portion of said tooth is a boundary between two layers of a tooth.

4. The method of claim 1 including the step of receiving at least one echo of said ultrasonic impulse from an area other than said tooth.

5. The method of claim 1 wherein step c) includes measuring the time delay between a first echo and a second echo.

6. The method of claim 5 including the step of measuring a layer of said tooth based on said reflection time.

7. The method of claim 5 including the step of measuring an area proximate said tooth based on said reflection time.

8. The method of claim 1 wherein step c) includes graphically displaying said at least one echo.

9. The method of claim 1 wherein step d) includes determining said geometry based upon a graphical display of said at least one echo.

10. The method of claim 1 wherein said ultrasonic impulse from said tooth includes an interface layer between said tooth and an adhesive.

11. A device for determining a tooth geometry comprising:
a transducer for generating an ultrasonic impulse;
a receiver for accepting at least one echo of said ultrasonic impulse from a portion of said tooth; and
a computer in communication with said receiver for generating a representation of said tooth geometry using said at least one echo.

12. The device of claim 11 wherein a handheld portion of said device includes said transducer and said receiver.

13. The device of claim 12 wherein said handheld portion includes an element for guiding said ultrasonic impulse.

14. The device of claim 13 including a sleeve for covering a portion of said element.

15. The device of claim 14 wherein said sleeve is a sterile/aseptic sleeve.

16. The device of claim 11 wherein said representation is a graphical representation.

17. The device of claim 11 wherein said representation is a measurement.

18. The device of claim 11 including a display for displaying said representation.

19. The device of claim 11 wherein said portion of said tooth is an adhesive-enamel or adhesive-dentin interface.
